(19) United States
(12) Patent Application Publication
(10) Pub. No.: US 2019/0320041 A1
(43) Pub. Date: Oct. 17, 2019

(54) CONTROL METHOD, RECORDING MEDIUM STORING CONTROL PROGRAM, AND INFORMATION PROCESSING APPARATUS

(71) Applicant: FUJITSU LIMITED, Kawasaki-shi (JP)

(72) Inventors: Yuriko Oshima, Kawasaki (JP); Ryohei MORISHITA, Yokohama (JP); Yuki Mochizuki, Kawasaki (JP); Kouji Abe, Kawasaki (JP); Junya Hiramatsu, Yokohama (JP)

(73) Assignee: FUJITSU LIMITED, Kawasaki-shi (JP)

(21) Appl. No.: 16/380,097

(22) Filed: Apr. 10, 2019

(30) Foreign Application Priority Data
Apr. 13, 2018 (JP) 2018-077376

(51) Int. Cl. H04L 29/08

(52) U.S. Cl. CPC H04L 67/32

(57) ABSTRACT

A control method includes: receiving, by a computer, a request of a process for an information processing system from a terminal device; transmitting the received request to the information processing system; acquiring first information associated with a content of the request by referring to a memory which stores information indicating a response content for the request in association with the content of the request; receiving second information that is transmitted from the information processing system and indicates the response content for the request; extracting third information different in the second information from the first information based on the first information and the second information; and controlling whether to transmit the second information to the terminal device or transmit the third information to the terminal device based on an information amount of the third information.

### CROSS-REFERENCE TO RELATED APPLICATION

This application is based upon and claims the benefit of priority of the prior Japanese Patent Application No. 2018-77376, filed on Apr. 13, 2018, the entire contents of which are incorporated herein by reference.

### FIELD

The embodiments discussed herein are related to a control method, a recording medium storing a control program, and an information processing apparatus.

### BACKGROUND

An intermediate server that has a function of authenticating a user, collecting an access log, and the like is arranged between a mobile terminal and a work system that is not open to the outside world.

The relating technology is disclosed in Japanese Laid-open Patent Publication No. 2017-097542, Japanese Laid-open Patent Publication No. 2003-248613, or Japanese Laid-open Patent Publication No. 2002-055870.

### SUMMARY

According to an aspect of the embodiments, a control method includes: receiving, by a computer, a request of a process for an information processing system from a terminal device; transmitting the received request to the information processing system; acquiring first information associated with a content of the request by referring to a memory which stores information indicating a response content for the request in association with the content of the request; receiving second information that is transmitted from the information processing system and indicates the response content for the request; extracting third information different in the second information from the first information based on the first information and the second information; and controlling whether to transmit the second information to the terminal device or transmit the third information to the terminal device based on an information amount of the third information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is one example of a service provision system;

FIG. 2 is one example of a hardware configuration of a mobile terminal;

FIG. 3 is one example of a hardware configuration of an intermediate server;

FIG. 4A is one example of a block diagram of the mobile terminal, the intermediate server, and a work server;

FIG. 4B is one example of a storage unit;

FIG. 5 is a process sequence diagram (1) illustrating one example of an operation of the service provision system;

FIG. 6 is a process sequence diagram (2) illustrating one example of the operation of the service provision system;

FIG. 7A is one example of a request;

FIG. 7B is one example of a response;

FIG. 8A is a first diagram for describing comparison of a response body;

FIG. 8B is a first diagram for describing the transmitted response body;

FIG. 9A is a second diagram for describing comparison of the response body;

FIG. 9B is a second diagram for describing the transmitted response body;

FIG. 10A is a third diagram for describing comparison of the response body;

FIG. 10B is a third diagram for describing the transmitted response body;

FIG. 11 is a part (1) of a process sequence diagram illustrating one example of the operation of the service provision system; and

FIG. 12 is a part (2) of the process sequence diagram illustrating one example of the operation of the service provision system.

### DESCRIPTION OF EMBODIMENTS

In a case where an intermediate server that has a function of authenticating a user, collecting an access log, and the like is arranged between a mobile terminal and a work system that is not open to the outside world, for example, access to the work system is performed through the intermediate server. For example, the intermediate server acquires a request transmitted from a client terminal or transmits a response to the client terminal. For example, various technologies related to the Internet are provided.

For example, a terminal device such as the mobile terminal or the client terminal may not have sufficient performance for processing the response transmitted by the intermediate server. In this case, the terminal device has a high load for processing the response, and there is a possibility that the terminal device does not smoothly operate.

For example, a control method or the like that may reduce the process load of the terminal device may be provided.

Hereinafter, embodiments will be described with reference to the drawings.

### FIRST EMBODIMENT

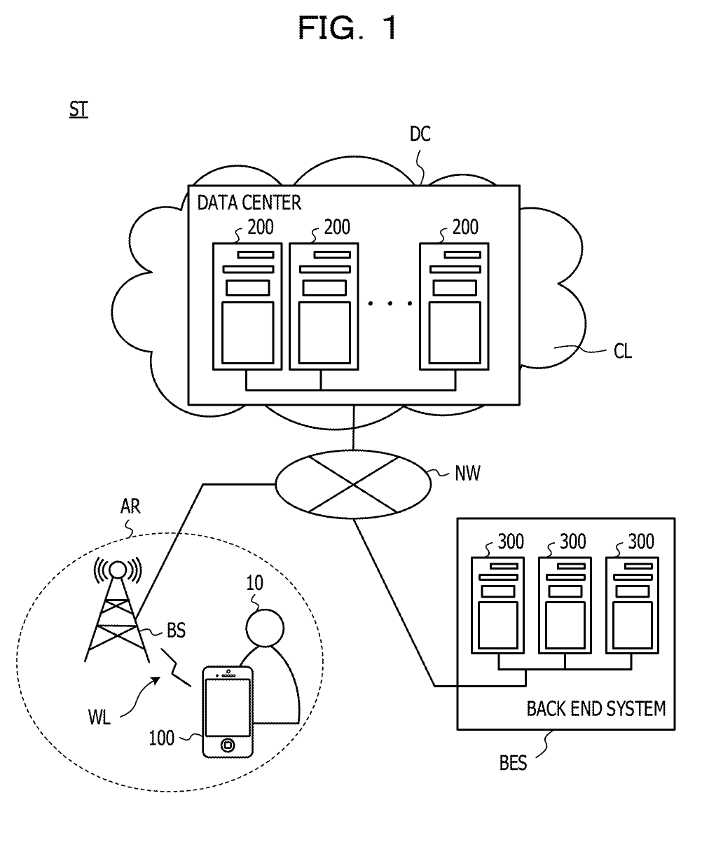

FIG. 1 is one example of a service provision system ST. The service provision system ST is a computer system that provides a cloud service such as provision of an application programming interface (API). The service provision system ST includes a mobile terminal 100 as a terminal device, an intermediate server 200 as an information processing apparatus, and a back end system BES as an information processing system. The back end system BES is a work system or the like of a company and includes a plurality of work servers 300 on each of which application software corresponding to work is installed. While a smartphone is illustrated as one example of the mobile terminal 100 in FIG. 1, the mobile terminal 100 may be a tablet terminal, a wearable terminal, or the like.

All of the mobile terminal 100, the intermediate server 200, and the plurality of work servers 300 are coupled through a communication network NW. For example, the mobile terminal 100 is coupled to the intermediate server 200 through a portable base station BS and the communication network NW. Accordingly, in a case where the mobile terminal 100 is included in a communicable range AR of the portable base station BS, the mobile terminal 100 may communicate with the portable base station BS by wireless communication WL. Accordingly, the mobile terminal 100 may communicate with the intermediate server 200. For example, the communication network NW is the Internet. The wireless communication WL is wide area wireless communication such as Long Term Evolution (LTE).

The intermediate server 200 is installed in a data center DC or the like on a cloud CL. The intermediate server 200 manages a plurality of APIs in representational state transfer (REST) format. The API is a program that executes application software executed by the back end system BES. The intermediate server 200 receives a process request (hereinafter, referred to as the request) transmitted from the mobile terminal 100 based on an operation by a user 10. The request may be called an API request or the like. In a case where the intermediate server 200 receives the request, the intermediate server 200 transmits the received request to the back end system BES. For example, in a case where the intermediate server 200 receives the request, the intermediate server 200 executes, from among a plurality of APIs, the API corresponding to information included in the request and transmits the request to any of the plurality of work servers 300 included in the back end system BES.

While the intermediate server 200 transmits the request in REST format to the back end system BES, the request received by the intermediate server 200 may be in REST format or may be in non-REST format different from REST format. In a case where the intermediate server 200 receives the request in non-REST format, the intermediate server 200 may convert the request in non-REST format into the request in REST format.

In a case where the back end system BES receives the request transmitted from the intermediate server 200, the back end system BES transmits a response to the request (hereinafter, referred to as the response) to the intermediate server 200. The response may be called an API response or the like. For example, in a case where any of the plurality of work servers 300 receives the request, the work server 300 that receives the request executes a process specified in the request based on application software and transmits the response including the execution result to the intermediate server 200.

In a case where the intermediate server 200 receives the response, the intermediate server 200 stores information (hereinafter, referred to as a response body) indicating the content of the received response in association with information (hereinafter, referred to as a request body) indicating the content of the request corresponding to the response. In a case where the intermediate server 200 stores the response body, the intermediate server 200 transmits the received response toward the mobile terminal 100. In a case where the mobile terminal 100 receives the response corresponding to the request, the mobile terminal 100 analyzes the received response and executes various processes depending on the analysis result. Accordingly, the mobile terminal 100 provides various information to the user 10. The intermediate server 200 executes various processes other than the process described above, and details of the processes executed by the intermediate server 200 will be described below.

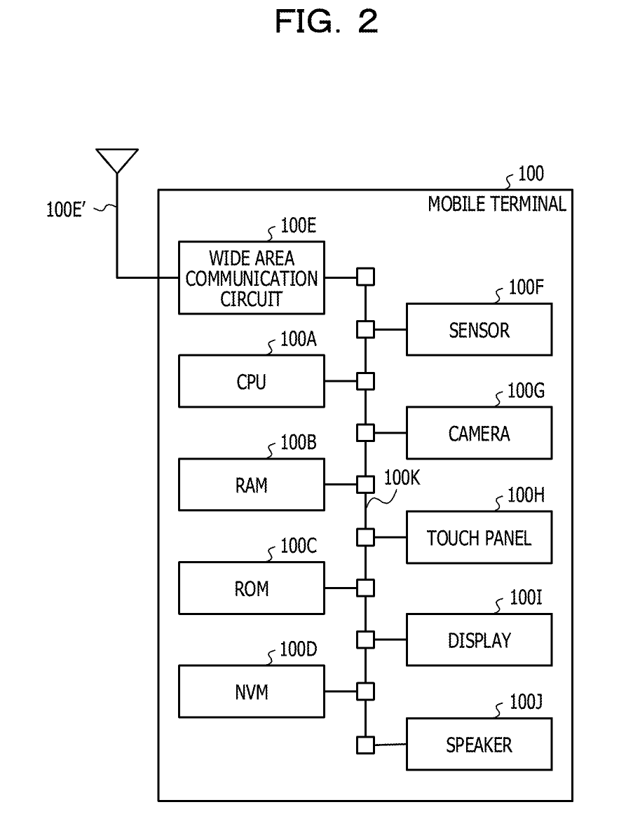

Next, a hardware configuration of the mobile terminal 100 will be described with reference to FIG. 2.

FIG. 2 is one example of the hardware configuration of the mobile terminal 100. As illustrated in FIG. 2, the mobile terminal 100 includes a central processing unit (CPU) 100A as a hardware processor, a random access memory (RAM) 100B, a read only memory (ROM) 100C, a non-volatile memory (NVM) 100D, and a wide area communication circuit 100E. The wide area communication circuit 100E is a hardware circuit that implements wide area wireless communication. An antenna 100E′ is coupled to the wide area communication circuit 100E.

In addition, the mobile terminal 100 includes a sensor 100F, a camera 100G, a touch panel 100H, a display 100I, and a speaker 1001 The CPU 100A to the speaker 100J are coupled to each other through an internal bus 100K. A micro processing unit (MPU) may be used as the hardware processor instead of the CPU 100A.

In the above-described RAM 100B, a program stored in the ROM 100C or the NVM 100D is temporarily stored by the CPU 100A. By executing the stored program by the CPU 100A, the CPU 100A implements various functions described below and executes various processes described below. The program may correspond to a process sequence diagram described below.

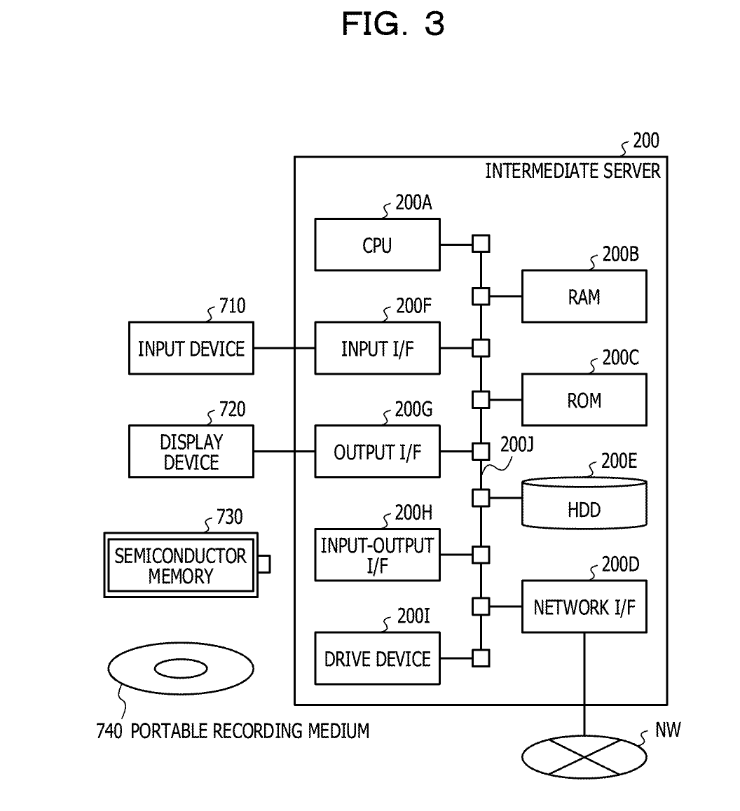

Next, a hardware configuration of the intermediate server 200 will be described with reference to FIG. 3.

FIG. 3 is one example of the hardware configuration of the intermediate server 200. The work server 300 basically has the same hardware configuration as the intermediate server 200. Thus, a description of the work server 300 will not be repeated. As illustrated in FIG. 3, the intermediate server 200 includes at least a CPU 200A as a hardware processor, a RAM 200B, a ROM 200C, and a network interface (I/F) 200D. An MPU may be used as the hardware processor instead of the CPU 200A. The intermediate server 200 may include, as desired, at least one of a hard disk drive (HDD) 200E, an input I/F 200F, an output I/F 200G, an input-output I/F 200H, and a drive device 2001. The CPU 200A to the drive device 2001 are coupled to each other through an internal bus 200J. For example, the intermediate server 200 may be implemented by a computer.

An input device 710 is coupled to the input I/F 200F. For example, the input device 710 is a keyboard, a mouse or the like. A display device 720 is coupled to the output I/F 200G. For example, the display device 720 is a liquid crystal display. A semiconductor memory 730 is coupled to the input-output I/F 200H. For example, the semiconductor memory 730 is a Universal Serial Bus (USB) memory, a flash memory or the like. The input-output I/F 200H reads a program or data stored in the semiconductor memory 730. For example, the input I/F 200F and the input-output I/F 200H include USB ports. For example, the output I/F 200G includes a display port.

A portable recording medium 740 is inserted into the drive device 2001. For example, the portable recording medium 740 is a removable disc such as a compact disc (CD)-ROM or a digital versatile disc (DVD). The drive device 2001 reads a program or data recorded on the portable recording medium 740. For example, the network I/F 200D includes a LAN port. The network I/F 200D is coupled to the communication network NW.

In the above-described RAM 200B, a program stored in the ROM 200C or the HDD 200E is temporarily stored by the CPU 200A. In the RAM 200B, the program recorded on the portable recording medium 740 is temporarily stored by the CPU 200A. By executing the stored program by the CPU 200A, the CPU 200A implements various functions described below and executes various processes described below. The program may correspond to a process sequence diagram described below.

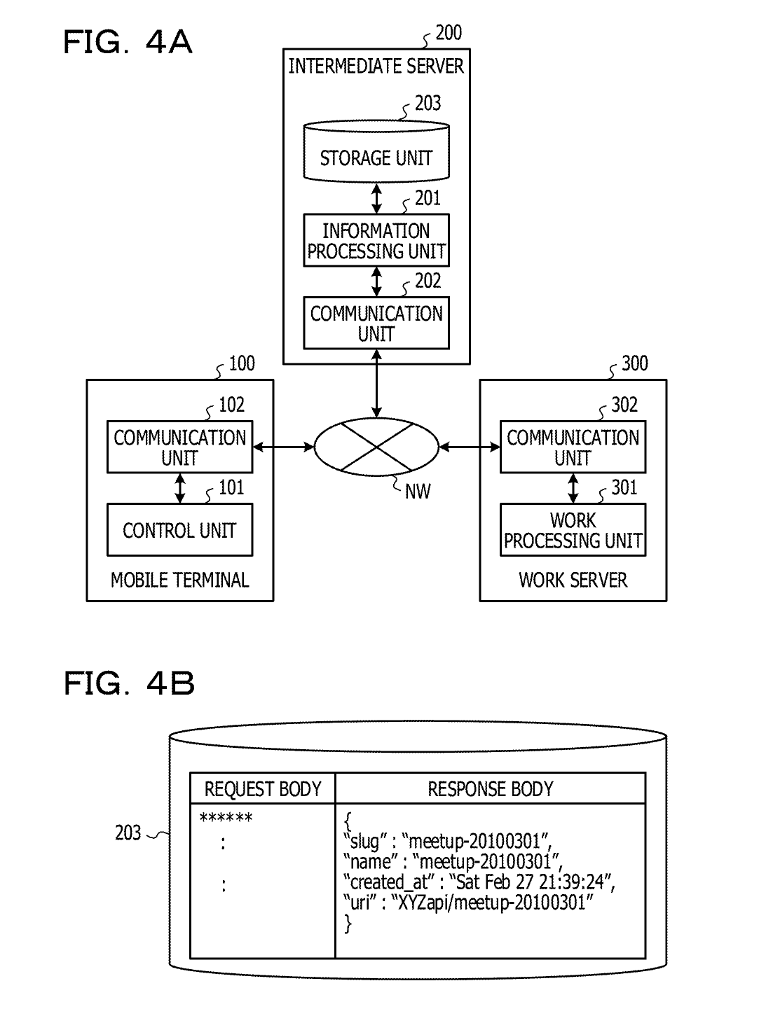

Next, the function of each of the mobile terminal 100, the intermediate server 200, and the work server 300 will be described with reference to FIGS. 4A and 4B.

FIG. 4A is one example of a block diagram of the mobile terminal 100, the intermediate server 200, and the work server 300. For example, in FIG. 4A, a main part of the function of each of the mobile terminal 100, the intermediate server 200, and the work server 300 is illustrated. FIG. 4B is one example of a storage unit 203.

First, the mobile terminal 100 will be described. The mobile terminal 100 includes a control unit 101 and a communication unit 102. The control unit 101 may be implemented by the above-described CPU 100A. The communication unit 102 may be implemented by the above-described wide area communication circuit 100E and the above-described antenna 100E′.

The control unit 101 controls the whole operation of the mobile terminal 100. For example, the control unit 101 generates the request based on an operation performed on the touch panel 100H (refer to FIG. 2) by the user 10 and outputs the request to the communication unit 102. For example, the control unit 101 receives the response output from the communication unit 102, analyzes the received response, and displays various information corresponding to the analysis result on the display 1001 (refer to FIG. 2). The communication unit 102 controls communication between the mobile terminal 100 and the intermediate server 200. For example, the communication unit 102 transmits the request output from the control unit 101 toward the intermediate server 200. In addition, the communication unit 102 receives the response transmitted from the intermediate server 200 and outputs the response to the control unit 101.

Next, the intermediate server 200 will be described. The intermediate server 200 includes an information processing unit 201, a communication unit 202, and the storage unit 203. The information processing unit 201 may be implemented by the above-described CPU 200A. The communication unit 202 may be implemented by the above-described network I/F 200D. The storage unit 203 may be implemented by the above-described RAM 200B or the above-described HDD 200E.

In a case where the information processing unit 201 receives the request output from the communication unit 202, the information processing unit 201 executes the API corresponding to the information included in the received request from the plurality of APIs managed by the intermediate server 200 and outputs the request in REST format to the communication unit 202. For example, in a case where the information processing unit 201 receives the response output from the communication unit 202, the information processing unit 201 stores the response body of the received response in the storage unit 203 in association with the request body of the previously received request. Accordingly, as illustrated in FIG. 4B, the storage unit 203 stores the response body in association with the request body.

In a case where the information processing unit 201 stores the response body in the storage unit 203, the information processing unit 201 outputs the received response to the communication unit 202. In addition, the information processing unit 201 calculates a cache period based on the frequency of execution of the API. Besides, the information processing unit 201 executes various processes, and details of the processes executed by the information processing unit 201 will be described below.

The communication unit 202 controls communication between the intermediate server 200 and the mobile terminal 100 and the back end system BES. For example, the communication unit 202 receives the request transmitted from the mobile terminal 100 and outputs the request to the information processing unit 201. The communication unit 202 receives the request output from the information processing unit 201 and transmits the request to the back end system BES. The communication unit 202 receives the response transmitted from the back end system BES and outputs the response to the information processing unit 201. The communication unit 202 receives the response output from the information processing unit 201 and transmits the response to the mobile terminal 100.

The above-described storage unit 203 stores the response body temporarily and not permanently. Thus, the storage unit 203 may be said to cache the response body. In this case, the period of temporary storage may be called the cache period. Accordingly, in a case where a time period more than the cache period elapses, the response body is deleted from the storage unit 203.

Next, the work server 300 will be described. The work server 300 includes a work processing unit 301 and a communication unit 302. The work processing unit 301 may be implemented by the above-described CPU 200A. The communication unit 302 may be implemented by the above-described network I/F 200D.

In a case where the work processing unit 301 receives the request output from the communication unit 302, the work processing unit 301 executes the process corresponding to the information included in the received request and generates the response. In a case where the work processing unit 301 generates the response, the work processing unit 301 outputs the generated response to the communication unit 302. The communication unit 302 controls communication between the work server 300 and the intermediate server 200. For example, the communication unit 302 receives the request transmitted from the intermediate server 200 and outputs the request to the work processing unit 301. The communication unit 302 receives the response output from the work processing unit 301 and transmits the response toward the intermediate server 200.

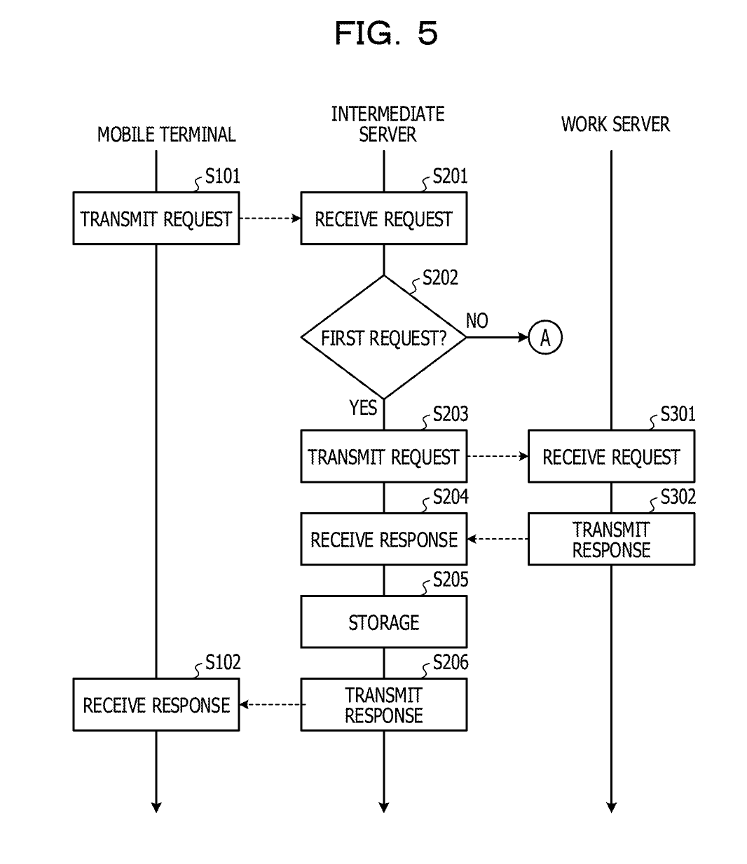

Next, an operation of the service provision system ST will be described with reference to FIG. 5 to FIG. 10B.

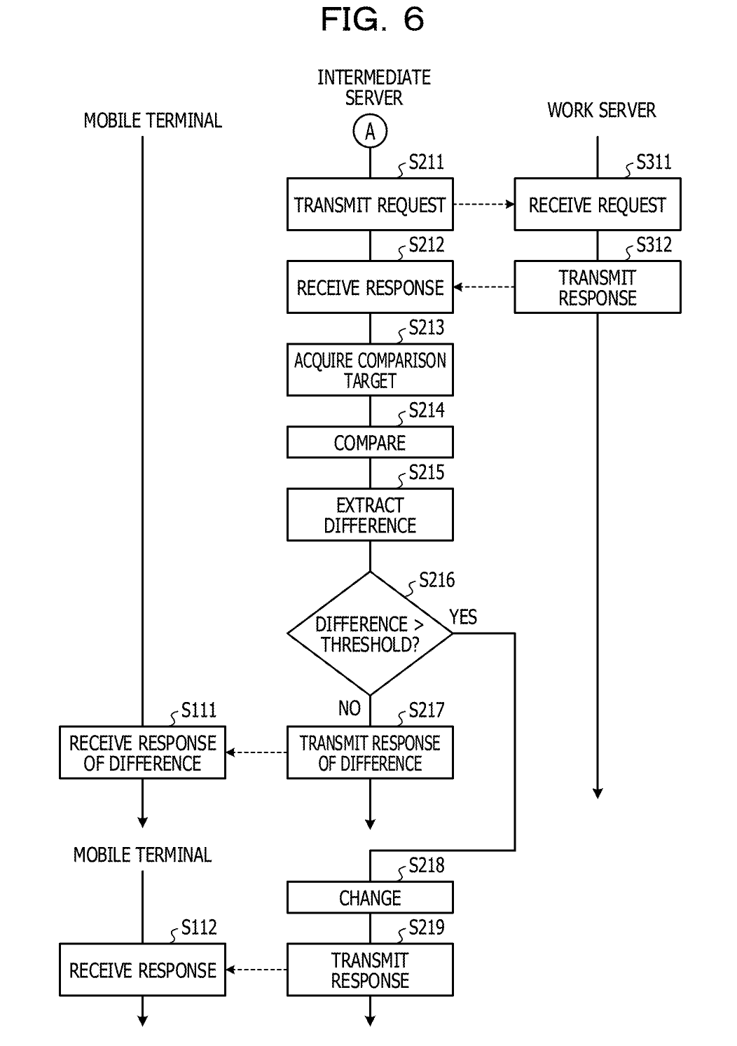

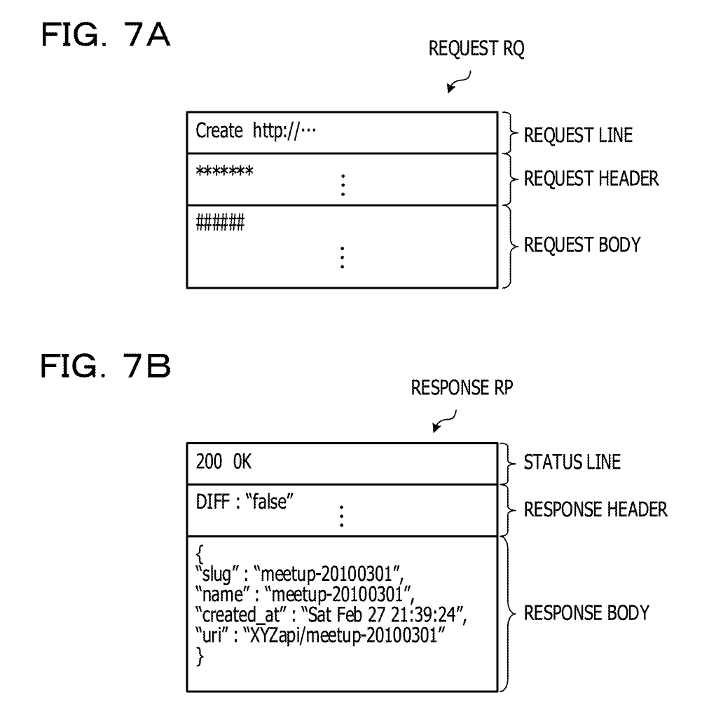

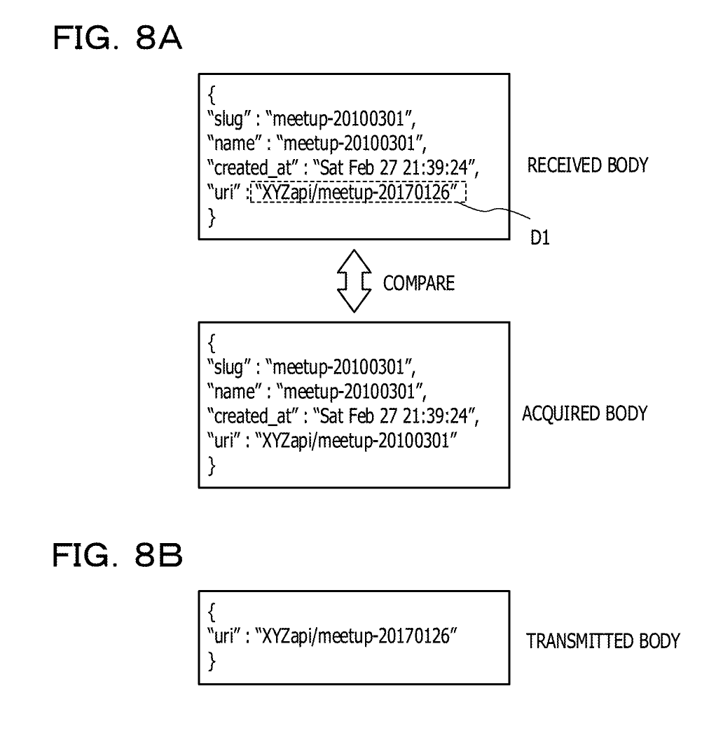

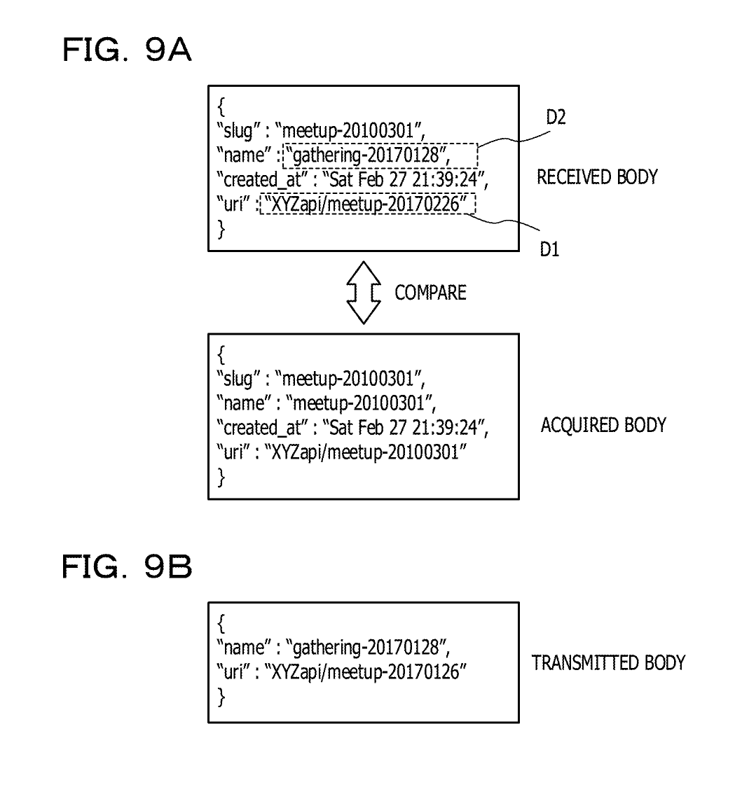

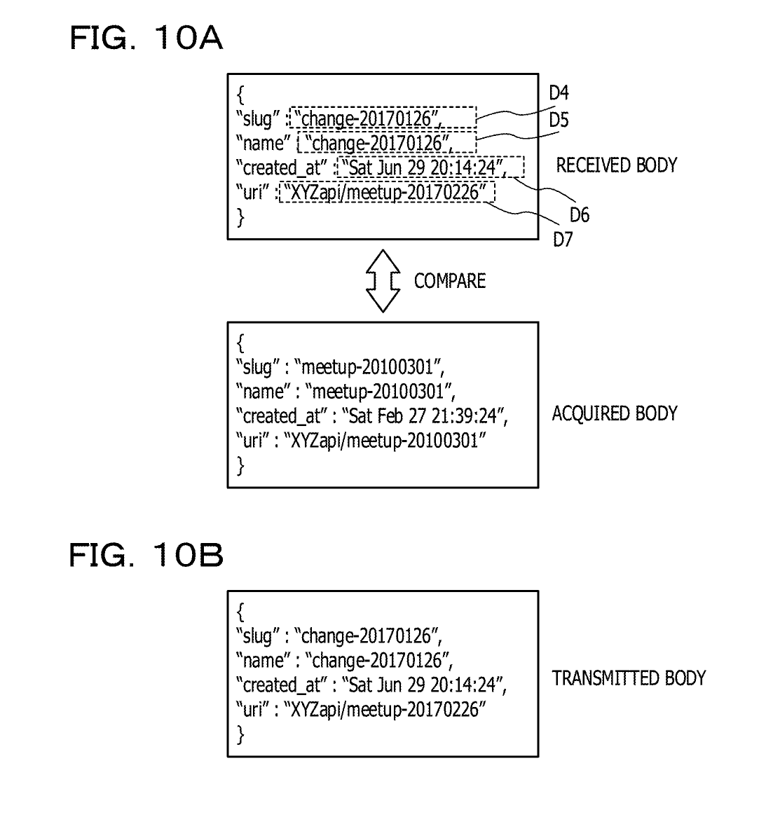

FIG. 5 is a process sequence diagram (1) illustrating one example of the operation of the service provision system ST. FIG. 6 is a process sequence diagram (2) illustrating one example of the operation of the service provision system ST. FIG. 7A is one example of a request RQ. FIG. 7B is one example of a response RP. FIG. 8A is a first diagram for describing comparison of the response body. FIG. 8B is a first diagram for describing the transmitted response body. FIG. 9A is a second diagram for describing comparison of the response body. FIG. 9B is a second diagram for describing the transmitted response body. FIG. 10A is a third diagram for describing comparison of the response body. FIG. 10B is a third diagram for describing the transmitted response body. The process sequence diagrams illustrated in FIG. 5 and FIG. 6 are coupled through a corresponding sign “A”.

First, as illustrated in FIG. 5, the communication unit 102 of the mobile terminal 100 transmits the request toward the intermediate server 200 (step S101). The communication unit 202 of the intermediate server 200 receives the request transmitted from the mobile terminal 100 (step S201).

As illustrated in FIG. 7A, the request RQ includes various information. For example, a method such as Create or Get is written as information in a request line that is the first line of the request RQ. The process executed by the work processing unit 301 may be specified by the method. In addition, a uniform resource locator (URL) such as https:// . . . is written as information in the request line. The URL includes an API name that is the name of the API, and a resource name that is the name of a resource. The API executed by the information processing unit 201 and the resource of a target on which the work processing unit 301 executes the process may be specified by the URL.

In addition, information called an authentication token, information called an API key, and the like are written in a request header that is from the second line of the request RQ. The authentication token is information for determining whether or not the user 10 has permission to use the cloud service provided by the service provision system ST. The API key is key information indicating that a caller program of the work server 300 has permission to use the API. Furthermore, a user ID that identifies the user 10, a terminal ID that identifies the mobile terminal 100, password information such as a password or a passphrase, or the like is written as information in the request body following the request header.

Returning to FIG. 5, in a case where the communication unit 202 of the intermediate server 200 receives the request, the information processing unit 201 determines whether or not the request is the first request (step S202). For example, in a case where the information processing unit 201 receives the request received by the communication unit 202, the information processing unit 201 refers to the storage unit 203. The information processing unit 201 determines whether or not the request is the first request by determining whether or not the storage unit 203 stores the response body associated with the same request body or the request body of the same type (hereinafter, simply referred to as the same request body) as the request body of the received request.

In a case where the storage unit 203 does not store the response body associated with the same request body as the request body of the received request, the information processing unit 201 determines that the request is the first request (step S202: YES). For example, in a case where the storage unit 203 does not store the response body associated with the request body including the same user ID as the user ID included in the request body of the received request, the information processing unit 201 determines that the request is the first request. In this case, the communication unit 202 transmits the request toward the work server 300 (step S203). Accordingly, the communication unit 302 of the work server 300 receives the request transmitted from the intermediate server 200 (step S301).

In a case where the communication unit 302 receives the request, the work processing unit 301 of the work server 300 executes the process specified in the request, and the communication unit 302 transmits the response including the process result to the intermediate server 200 (step S302). Accordingly, the communication unit 202 of the intermediate server 200 receives the response transmitted from the work server 300 (step S204).

As illustrated in FIG. 7B, the response RP includes various information. For example, a status code is written as information in a status line that is the first line of the response RP. A success or a failure of the process is specified by the status code. For example, a status code “200” represents the success of the process, and a status code “500” represents the failure of the process.

In addition, a transmission type of the response RP to be transmitted to the mobile terminal 100 is written as information in a response header that is from the second line of the response RP. For example, a transmission type “DIFF”: “false” represents that the response including the response body received by the communication unit 202 as it is is transmitted to the mobile terminal 100. While details will be described below, a transmission type “DIFF”: “true” represents that the response including the difference of the response body received by the communication unit 202 is transmitted to the mobile terminal 100. Furthermore, the process result of the process of the work processing unit 301 is written as information in the response body following the response header.

Returning to FIG. 5, in the process of step S204, in a case where the communication unit 202 of the intermediate server 200 receives the response, the information processing unit 201 stores the response body in the storage unit 203 (step S205). For example, the information processing unit 201 stores the response body of the response received by the communication unit 202 in the storage unit 203 in association with the request body of the request received by the communication unit 202 in the process of step S201. Accordingly, the storage unit 203 stores the response body associated with the request body (refer to FIG. 4B).

In a case where the process of step S205 is completed, the communication unit 202 transmits the response toward the mobile terminal 100 (step S206). For example, in the process of step S202, in a case where the information processing unit 201 determines that the request is the first request, the communication unit 202 transmits the response including the transmission type “DIFF”: “false” in the response header toward the mobile terminal 100. The communication unit 102 of the mobile terminal 100 receives the response transmitted from the intermediate server 200 (step S102). The control unit 101 processes the response based on the transmission type of the response received by the communication unit 102. For example, in a case where the transmission type “DIFF”: “false” is included in the response header, the control unit 101 analyzes the whole information included in the response body and displays information corresponding to the analysis result on the display 100I.

In the process of step S202, in a case where the storage unit 203 stores the response body associated with the same request body as the request body of the received request, the information processing unit 201 determines that the request is not the first request (step S202: NO). For example, in a case where the storage unit 203 stores the response body associated with the request body including the same user ID as the user ID included in the request body of the received request, the information processing unit 201 determines that the request is not the first request. For example, in a case where the information processing unit 201 determines that the request is the second request based on the number of request bodies, the communication unit 202 transmits the request toward the work server 300 as illustrated in FIG. 6 (step S211). Accordingly, the communication unit 302 of the work server 300 receives the request transmitted from the intermediate server 200 (step S311).

In a case where the communication unit 302 receives the request, the work processing unit 301 of the work server 300 executes the process specified in the request, and the communication unit 302 transmits the response including the process result to the intermediate server 200 (step S312). Accordingly, the communication unit 202 of the intermediate server 200 receives the response transmitted from the work server 300 (step S212).

In a case where the communication unit 202 of the intermediate server 200 receives the response, the information processing unit 201 acquires the response body of a comparison target from the storage unit 203 (step S213). For example, based on the information (for example, the user ID or the terminal ID) written in the request body of the request corresponding to the response received by the communication unit 202, the information processing unit 201 acquires the response body associated with the request body having the same information as the information.

In a case where the process of step S213 is completed, the information processing unit 201 compares the response body of the response received by the communication unit 202 with the response body acquired from the storage unit 203 (step S214) and extracts difference information (step S215). For example, as illustrated in FIG. 8A, the information processing unit 201 compares the response body (written as received body in FIG. 8A) of the received response with the acquired response body (written as acquired body in FIG. 8A) and extracts information different in the received response body from the acquired response body as the difference information. Accordingly, as illustrated in FIG. 8A, the information processing unit 201 extracts difference information D1.

In a case where the process of step S215 is completed, next, the information processing unit 201 determines whether or not the amount of the difference information is larger than a threshold (step S216). The threshold represents a reference amount for determining the magnitude of the amount of the difference information. For example, as illustrated in FIG. 8A, in a case where only an item “uri” is the difference among four items “slug”, “name”, “created_at”, and “uri”, the information processing unit 201 determines that the amount of the difference information is smaller than or equal to the threshold (step S216: NO).

In this case, the communication unit 202 transmits the response of the difference toward the mobile terminal 100 (step S217). For example, in a case where the information processing unit 201 determines that the amount of the difference information is smaller than or equal to the threshold, the communication unit 202 transmits the response including the transmission type “DIFF: “true” in the response header. As illustrated in FIG. 8B, the communication unit 202 transmits the response including the difference information D1 in the response body (written as transmitted body in FIG. 8B).

In a case where the process of step S217 is completed, the communication unit 102 of the mobile terminal 100 receives the response of the difference (step S111). In a case where the communication unit 102 receives the response of the difference, the control unit 101 executes the process corresponding to the response of the difference. For example, the control unit 101 executes the process for information corresponding to the difference information D1 without executing the process for information other than the information corresponding to the difference information D1. Accordingly, the process load of the mobile terminal 100 is reduced.

While the case of the second request is described as one example of the case of the non-first request in the process of above-described step S202, the case of the third request is basically the same as the case of the second request.

For example, as illustrated in FIG. 9A, the information processing unit 201 compares the response body (written as received body in FIG. 9A) of the received response with the acquired response body (written as acquired body in FIG. 9A) and extracts information different in the received response body from the acquired response body as the difference information. Accordingly, as illustrated in FIG. 9A, the information processing unit 201 extracts two pieces of difference information D2 and D3. In this case, as illustrated in FIG. 9B, the communication unit 202 transmits the response including the difference information D2 and D3 in the response body (written as transmitted body in FIG. 9B). Even in the case of the third request, the information amount of the response received by the mobile terminal 100 is smaller than the information amount of the response received in a case where there is no difference. Thus, the process load of the mobile terminal 100 may be reduced.

In the process of step S216 illustrated in FIG. 6, in a case where the information processing unit 201 determines that the amount of the difference information is larger than the threshold (step S216: YES), the information processing unit 201 changes the response body stored in the storage unit 203 (step S218). For example, as illustrated in FIG. 10A, in a case where all of the four items “slug”, “name”, “created_at”, and “uri” are the difference, the information processing unit 201 determines that the amount of the difference information is larger than the threshold.

In this case, the information processing unit 201 changes the response body stored in the storage unit 203 to the response body of the response received by the communication unit 202 in the process of step S212. For example, the information processing unit 201 deletes the response body stored in the storage unit 203 and stores the response body of the response received in the process of step S212 in the storage unit 203 in association with the request body of the request received by the communication unit 202 in the process of step S201. Accordingly, even in a case where the time period more than the cache period elapses for the response body stored in the storage unit 203, the response body is appropriately updated to a new request body.

In a case where the process of step S218 is completed, the communication unit 202 transmits the response toward the mobile terminal 100 (step S219). For example, in a case where the information processing unit 201 determines that the amount of the difference information is larger than the threshold, the communication unit 202 transmits the response including the transmission type “DIFF”: “true” in the response header. The response transmitted by the communication unit 202 includes difference information D4, D5, D6, and D7 in the response body (written as transmitted body in FIG. 10B) as illustrated in FIG. 10B.

The information processing unit 201 decides the above-described threshold based on a correspondence table in which two frequencies of the frequency of execution of the API and the frequency of change of the response body are associated with the threshold. For example, in a case where both of the frequency of execution of the API and the frequency of change of the response body are low, the above-described threshold is decided to be a small threshold based on the correspondence table. For example, in a case where the difference frequently occurs, and the cache period of the response body is lengthened, the information processing unit 201 decides the threshold to be a small threshold. Accordingly, the communication unit 202 transmits the response having a restrained information amount of the response body with high frequency.

According to the first embodiment, the intermediate server 200 includes the information processing unit 201 and the communication unit 202. In a case where the communication unit 202 receives the request of a process for the back end system BES from the mobile terminal 100, the communication unit 202 transmits the received request to the back end system BES. The information processing unit 201 acquires the response body associated with the request body of the received request by referring to the storage unit 203.

In a case where the communication unit 202 receives the response to the request from the back end system BES in response to the transmission of the request, the information processing unit 201 extracts the difference information different in the response body of the received response from the acquired response body by comparing the response body indicating the content of the response received by the communication unit 202 with the acquired response body. The information processing unit 201 executes a process of controlling whether to transmit the received response to the mobile terminal 100 or transmit the response of the extracted difference information to the mobile terminal 100 based on the information amount of the extracted difference information.

Accordingly, the process load of the mobile terminal 100 may be reduced. In addition, since the information amount of the response received by the mobile terminal 100 is limited, a bottleneck caused by communication may be reduced even in a case where the communication environment of the mobile terminal 100 is an environment (for example, a mountainous area or a remote area) in which high speed communication may not be used. Furthermore, even in a case where a communication contract for the mobile terminal 100 is based on a measured rate, the amount of communication may be reduced for the same reason.

### SECOND EMBODIMENT

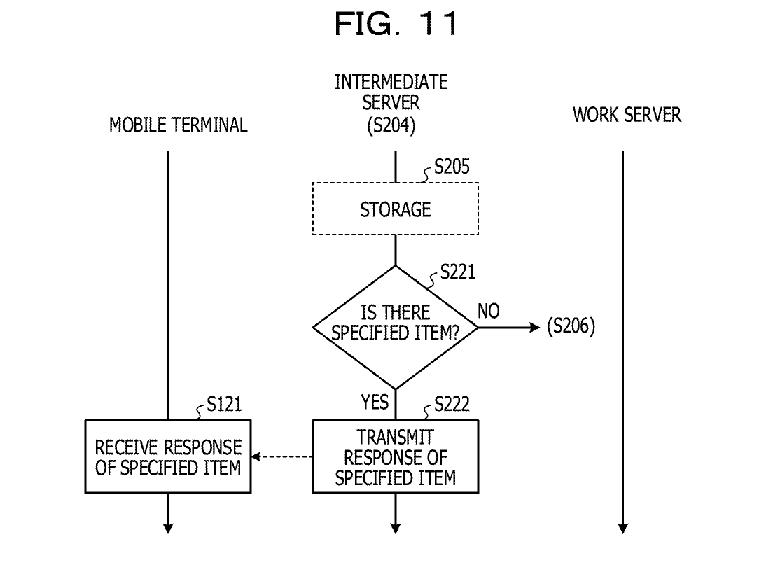

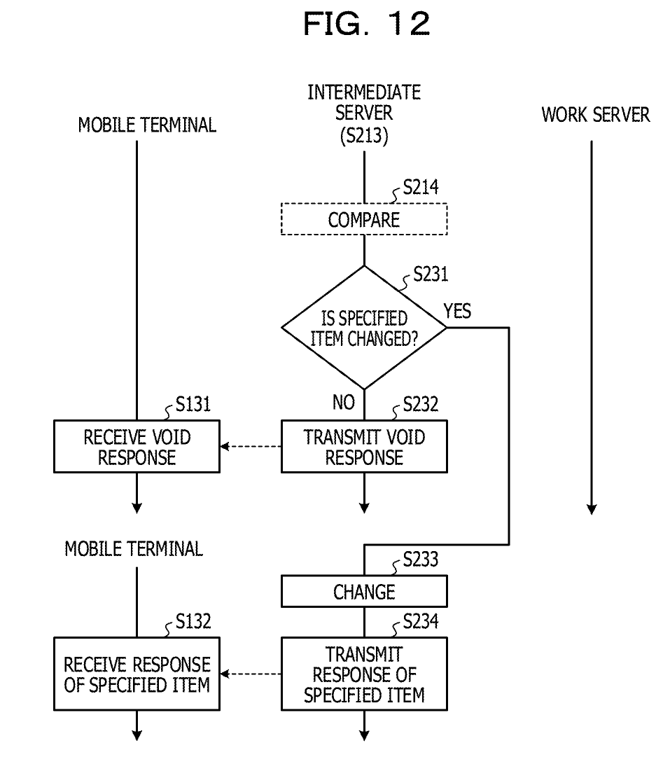

Next, a second embodiment will be described with reference to FIG. 11 and FIG. 12. FIG. 11 is a part (1) of a process sequence diagram illustrating one example of the operation of the service provision system ST. FIG. 12 is a part (2) of a process sequence diagram illustrating one example of the operation of the service provision system ST. As illustrated in FIG. 11, instead of the process of step S206 described in the first embodiment, the service provision system ST may include a process of step S221 or the like after the process of step S205. In addition, as illustrated in FIG. 12, instead of the processes of steps S215 to S219 described in the first embodiment, the service provision system ST may include a process of step S231 or the like after the process of step S214.

For example, as illustrated in FIG. 11, in a case where the process of step S205 is completed, the information processing unit 201 of the intermediate server 200 determines whether or not there is a specified item (step S221). For example, in a case where the mobile terminal 100 uses information corresponding to a specific item in the response body for processing and does not use information corresponding to the remaining items other than the specific item for processing, the control unit 101 specifies the specific item as a path in definition information managed by the intermediate server 200. The definition information is information indicating a definition of the API managed by the intermediate server 200. Accordingly, the information processing unit 201 determines whether or not there is a specified item by referring to the definition information.

In a case where the information processing unit 201 determines that there is a specified item (step S221: YES), the communication unit 202 transmits the response of the specified item toward the mobile terminal 100 (step S222). For example, in a case where a specific item “uri” is specified as a JSON path, an Xpath, or the like in the definition information, the information processing unit 201 determines that there is a specified item. In this case, the communication unit 202 transmits the response including the specified item and information corresponding to the item as a transmission target toward the mobile terminal 100. Accordingly, the communication unit 102 of the mobile terminal 100 receives the response including the specified item and the information corresponding to the item (step S121). Accordingly, in a case where a specific item “uri” is specified in the definition information, the control unit 101 uses information corresponding to the item “uri” for processing and does not use information corresponding to the remaining plurality of items “slug”, “name”, and “created_at” for processing. Accordingly, the process load of the mobile terminal 100 may be reduced.

In addition, as illustrated in FIG. 12, in a case where the process of step S214 is completed, the information processing unit 201 of the intermediate server 200 determines whether or not the information corresponding to the specified item is changed (step S231). For example, in a case where the information corresponding to the specified item “uri” is not different as a result of comparison between two response bodies, the information processing unit 201 determines that the information corresponding to the specified item is not changed (step S231: NO). In this case, the communication unit 202 transmits the response having a void (empty) content of the response body toward the mobile terminal 100 (step S232). Accordingly, the communication unit 102 of the mobile terminal 100 receives the void (empty) response (step S131). Since the communication unit 102 receives the response not including the content of the response body, the control unit 101 does not execute the process that is executed in a case where information is present in the response body. Consequently, the process load of the mobile terminal 100 may be reduced.

In a case where the information corresponding to the specified item “uri” is different as a result of comparison between two response bodies, the information processing unit 201 determines that the information corresponding to the specified item is changed (step S231: YES). In this case, the information processing unit 201 changes the response body stored in the storage unit 203 (step S233). In a case where the process of step S233 is completed, the communication unit 202 transmits the response of the specified item toward the mobile terminal 100 in the same manner as the process of above-described step S222 (step S234). Accordingly, the communication unit 102 of the mobile terminal 100 receives the response of the specified item (step S132). Accordingly, in a case where a specific item “uri” is specified in the definition information, the control unit 101 uses information corresponding to the item “uri” for processing and does not use information corresponding to the remaining plurality of items “slug”, “name”, and “created_at” for processing. Accordingly, the process load of the mobile terminal 100 may be reduced.

While desirable embodiments are described thus far, the embodiments are not limited to a specific embodiment. Various modifications and changes may be made within the gist of the embodiments disclosed in the claims. For example, while wide area wireless communication is described as one example of the wireless communication WL in the above-described embodiments, short-range wireless communication such as Wi-Fi (registered trademark) or Bluetooth (registered trademark) may be used as the wireless communication WL.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control method comprising:
receiving, by a computer, a request of a process for an information processing system from a terminal device;
transmitting the received request to the information processing system;
acquiring first information associated with a content of the request by referring to a memory which stores information indicating a response content for the request in association with the content of the request;
receiving second information that is transmitted from the information processing system and indicates the response content for the request;
extracting third information different in the second information from the first information based on the first information and the second information; and
controlling whether to transmit the second information to the terminal device or transmit the third information to the terminal device based on an information amount of the third information.

2. The control method according to claim 1,
wherein the first information is changed to the second information in a case where the information amount of the third information exceeds a reference amount.

3. The control method according to claim 2,
wherein the reference amount is decided based on a frequency of execution of a program which executes an application software which is executed by the information processing system in response to the request and a frequency of change of the first information to the second information.

4. The control method according to claim 1,
wherein a storage period of the first information which is stored in the memory is calculated based on a frequency of execution of a program which executes an application software which is executed by the information processing system in response to the request.

5. The control method according to claim 1,
wherein second specific information that is specified as a transmission target in the second information is compared with first specific information corresponding to the second specific information in the first information, and
information not including the second information is transmitted in a case where there is no change between the second specific information and the first specific information.

6. A non-transitory computer-readable recording medium recording a control program which causes a computer to execute a process, the process comprising:
receiving a request of a process for an information processing system from a terminal device;
transmitting the received request to the information processing system;
acquiring first information associated with a content of the request by referring to a memory which stores information indicating a response content for the request in association with the content of the request;
receiving second information that is transmitted from the information processing system and indicates the response content for the request;
extracting third information different in the second information from the first information based on the first information and the second information; and
controlling whether to transmit the second information to the terminal device or transmit the third information to the terminal device based on an information amount of the third information.

7. The non-transitory computer-readable recording medium according to claim 6,
wherein the first information is changed to the second information in a case where the information amount of the third information exceeds a reference amount.

8. The non-transitory computer-readable recording medium according to claim 7,
wherein the reference amount is decided based on a frequency of execution of a program which executes an application software which is executed by the information processing system in response to the request and a frequency of change of the first information to the second information.

9. The non-transitory computer-readable recording medium according to claim 6,
wherein a storage period of the first information which is stored in the memory is calculated based on a frequency of execution of a program which executes an application software which is executed by the information processing system in response to the request.

10. The non-transitory computer-readable recording medium according to claim 6,
wherein second specific information that is specified as a transmission target in the second information is compared with first specific information corresponding to the second specific information in the first information, and
information not including the second information is transmitted in a case where there is no change between the second specific information and the first specific information.

11. An information processing apparatus comprising:
a memory; and
a processor coupled to the memory and configured to execute a process of:
receiving a request of a process for an information processing system from a terminal device;
transmitting the received request to the information processing system;
acquiring first information associated with a content of the request by referring to a memory which stores information indicating a response content for the request in association with the content of the request;
receiving second information that is transmitted from the information processing system and indicates the response content for the request;
extracting third information different in the second information from the first information based on the first information and the second information; and
controlling whether to transmit the second information to the terminal device or transmit the third information to the terminal device based on an information amount of the third information.

12. The information processing apparatus according to claim 11,
wherein the first information is changed to the second information in a case where the information amount of the third information exceeds a reference amount.

13. The information processing apparatus according to claim 12,
wherein the reference amount is decided based on a frequency of execution of a program which executes an application software which is executed by the information processing system in response to the request and a frequency of change of the first information to the second information.

14. The information processing apparatus according to claim 11,
wherein a storage period of the first information which is stored in the memory is calculated based on a frequency of execution of a program which executes an application software which is executed by the information processing system in response to the request.

15. The information processing apparatus according to claim 11,
wherein second specific information that is specified as a transmission target in the second information is compared with first specific information corresponding to the second specific information in the first information, and
information not including the second information is transmitted in a case where there is no change between the second specific information and the first specific information.
